(19) United States
(12) Patent Application Publication
(10) Pub. No.: US 2018/0081400 A1
(43) Pub. Date: Mar. 22, 2018

(54) ELECTRONIC DEVICES WITH SEALING ELEMENTS HAVING EMBEDDED SENSORS

(71) Applicant: Apple Inc., Cupertino, CA (US)

(72) Inventors: Sameer PANDYA, Sunnyvale, CA (US); Rui QIAO, Sunnyvale, CA (US); Richard D. SHUMA, San Jose, CA (US); William GREENBAUM, Mountain View, CA (US)

(21) Appl. No.: 15/272,167

(22) Filed: Sep. 21, 2016

(51) Int. Cl. G06F 1/16; F16J 15/02; G06F 3/041; G06F 3/045; G06F 3/044

(52) U.S. Cl. CPC G06F 1/1656; F16J 15/022; G06F 3/0414; G06F 1/1626; G06F 3/045; G06F 3/044; G06F 3/0416

(57) ABSTRACT

An electronic device having a housing that defines an interior volume, the housing being suitable for carrying at least a processor within the internal volume, the housing comprising an edge that defines an opening that provides access to the internal volume. The electronic device can have a cover carried at the edge of the housing and within the opening and having an external surface capable of receiving an external force and a sealing element disposed between the housing and the cover, with the sealing element preventing intrusion of liquid into the internal volume. The sealing element can include a sealing material and a sensor contained within the sealing material that senses that an external force is applied to the external surface of the cover and, in response, provides a signal to the processor.

### FIELD

The described embodiments relate to an electronic device. In particular, the described embodiments relate to an electronic device that can include a sealing element that provides a seal between two or more parts. In addition to its sealing capabilities, the sealing element can contain an embedded force sensor or sensors that can detect a force (or forces) applied to one of the parts.

### BACKGROUND

Electronic devices are known to have multiple parts sealed together. The region in which the parts are sealed together may define an interface region. The interface region may allow ingress of liquids or contaminants that exist in the environments in which the electronic device is used. This interface region can contain a sealing element for preventing ingress of the liquids or contaminants. The interface region can also sometimes contain functional components that are used for operation of the electronic device. For instance, sometimes force sensors are located within this interface region that can detect forces applied to the parts, either due to naturally occurring conditions, such as water pressure or atmospheric pressure, or due to an input force imparted by a user. Sensors are sometimes held in place by pressure sensitive adhesive (PSA). PSA not only holds the sensor in place, but it can provide some resistance to liquid and/or contaminant intrusion, such as water intrusion, and as such, is part of the element that resists liquid intrusion. PSA, however, has a tendency to breakdown over time when exposed to chemicals such as oils generated by users. This can reduce the PSA's effectiveness in resisting liquid ingress as well as its adhering ability.

### SUMMARY

Some embodiments of the present disclosure include an electronic device having a housing that defines an interior volume, the housing being suitable for carrying at least a processor within the internal volume, the housing comprising an edge that defines an opening that provides access to the internal volume. The electronic device can have a cover carried at the edge of the housing and having an external surface capable of receiving an external force and a sealing element disposed between the housing and the cover, with the sealing element preventing intrusion of liquid into the internal volume. The sealing element can include a sealing material and a sensor contained within the sealing material that senses that an external force is applied to the external surface of the cover and, in response, provides a signal to the processor.

Some embodiments can include a portable electronic device having an enclosure defining an internal cavity configured for carrying electronic components including at least a processor and a display, the enclosure having an edge at an opening to the internal cavity and a cover glass disposed on the edge and over the display such that visual content is displayed through the cover glass, the cover glass being coupled to enclosure. The portable electronic device can have a liquid impermeable barrier compressed between the cover glass and the edge such that liquid is prevented from permeating into the internal cavity of the enclosure, where the liquid impermeable barrier can include a sensor embedded within the liquid impermeable barrier that can detect a force applied to an external surface of the cover glass and provide a signal to the processor.

Some embodiments can include method for detecting a touch force input received at an external surface of a first component of a multi-part electronic device enclosure, where the first component is coupled to a second component and sealed from liquid permeation by a sealing element embedded with a force sensor arranged between the first component and the second component. The method can include receiving a force at an external surface of the first or second component, detecting the force received by the protective cover and transmitted to the sealing element, using the embedded force sensor, and generating a signal to provide to a processor contained within the multi-part electronic device enclosure based on the detected force.

Other systems, methods, features and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a plan view of an embodiment of an electronic device, in accordance with the described embodiments;

FIG. 2 illustrates a plan view of the electronic device shown in FIG. 1, showing several internal components of the electronic device;

FIG. 3A illustrates a front schematic cross section view of the electronic device shown in FIG. 2 taken along cross-section A-A showing one sealing arrangement embodiment;

FIG. 3B illustrates a side cross-section view of the electronic device shown in FIG. 2 taken along B-B of FIG. 3A;

FIGS. 4A and 4B illustrate a sealing element with an embedded sensor in an alternative sealing arrangement embodiment;

FIG. 5 illustrates an alternative embodiment of an embedded sensor of the electronic device shown in FIG. 2;

FIG. 6 illustrates an alternative embodiment of an embedded sensor in accordance with the described embodiments where multiple sensors are embedded along the sealing element;

FIG. 7 illustrates a flowchart showing a method for detecting a force imparted on an external surface of a protective cover of the electronic device of FIG. 1; and

FIG. 8 is a block diagram of a computing device that can represent some of the components of the electronic device of FIG. 1.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments may be used, and changes may be made without departing from the spirit and scope of the described embodiments.

The described embodiments relate to electronic devices where a sealing element can be used to provide a seal against ingress of liquid into the electronic device. In some embodiments, the sealing element is secured between a protective cover (such as a cover glass of the electronic device) and an enclosure of the electronic device. In this regard, the sealing element is positioned to limit or prevent ingress through an interface between the protective cover and the enclosure.

In addition the sealing element can include a sensor that can detect forces applied to the protective cover that are transmitted through the protective cover to the sealing element. In some embodiments, the sensor can be embedded within the sealing element. Embedding the sensor within the sealing element can make it possible to avoid using pressure sensitive adhesives to hold the sealing element and force sensing components together or to couple the sealing element to the enclosure and protective cover.

In some embodiments, the sensor may be a strain gauge type sensor where conductive material embedded in a predetermined shape or pattern within the sealing element can change electrical resistance when its shape is modified due to an imparted force. In some embodiments, the force applied to the protective cover can cause a compressive force on the sealing element. In other embodiments, the force applied to the protective cover can cause a shear force to be exhibited by the sealing element. This can cause the embedded sensor to exhibit twisting or contortion. The change in electrical resistance due to the change in shape of the embedded sensor can be used to determine the amount of force applied to the protective cover and sealing element.

In some embodiments, the sensor may also be a capacitive force sensor where several components can combine to form a force detection sensor system designed to detect or monitor an amount of force applied to the protective cover. In these embodiments, the sealing element may include a pair of flexible circuits separated by a region of the sealing element material, where one of the flexible circuits can carry an electric charge such that the sealing element includes a capacitance, or capacitance value. The flexible circuits can be spaced apart by the sealing element material, which can be a dielectric material. Dielectric materials are non-conductive, but can be polarized by an electric field. As such, the sealing element may take the form of a parallel plate capacitor using the flexible circuit as plates separated by the dielectric material of the sealing element. In response to a force, the sealing element may compress, causing the distance between the plates to decrease, as the region between the plates would also compress. In turn, this causes the capacitance of the sealing element to change. In turn, this change in capacitance can be used to detect a force applied to the protective cover. The force may occur by a user depressing the protective cover, which transmits at least some force to the sealing element. Also, the change in distance is proportional to the change in capacitance. Accordingly, the capacitance may correspond to an amount of force applied to the cover glass.

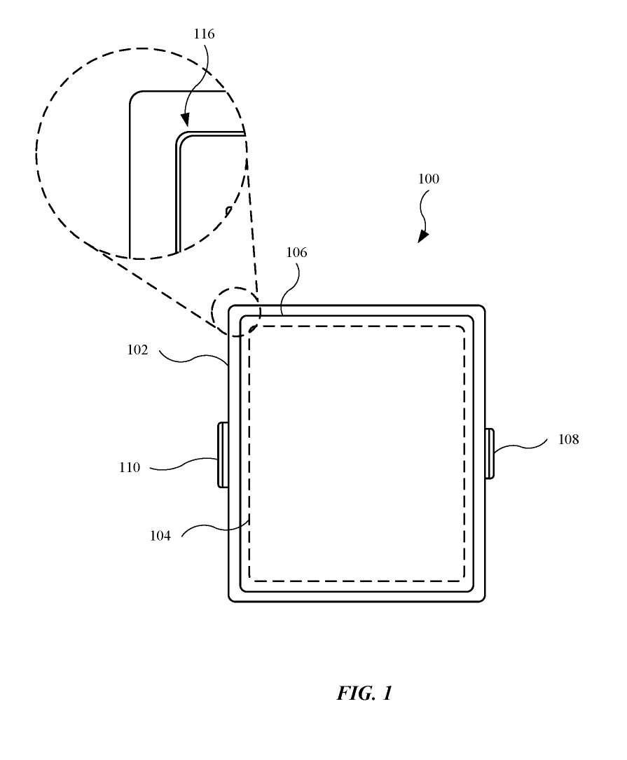

These and other embodiments are discussed below with reference to FIGS. 1-8. However, those skilled in the art will readily appreciate that the detailed description given herein with respect to these Figures is for explanatory purposes only and should not be construed as limiting.

FIG. 1 illustrates a plan view of an embodiment of an electronic device 100, in accordance with the described embodiments. In some embodiments, the electronic device 100 is a tablet device. In other embodiments, the electronic device 100 is a mobile wireless communication device, such as a smartphone. Still, in other embodiments, the electronic device 100 is a wearable electronic device, similar to a watch. When the electronic device 100 is a wearable electronic device, the electronic device 100 may include one or more bands (not shown) designed to wrap around an appendage (a wrist, for example) of a user.

As shown, the electronic device 100 may include an enclosure 102. In some embodiments, the enclosure 102 is formed from a metal, which may include aluminum, stainless steel, ceramic or glass, as non-limiting examples. In other embodiments, the enclosure 102 includes a metal alloy. The electronic device 100 may further include a display assembly 104 (shown as a dotted line) designed to present visual information. The display assembly 104 may, in some embodiments, be an input interface and include a touch-sensitive display assembly designed to respond to a capacitive element (not shown) coupled with the display assembly 104. The electronic device 100 may further include a protective cover 106 that overlays the display assembly 104. The protective cover 106 may include a material, such as glass or sapphire that provides a transparent protective layer for the display assembly 104. The protective cover can be curved or flat and can interface with the enclosure in various different ways, some of which will be discussed in the disclosed embodiments.

Also, the electronic device 100 may include one or more additional input features, such as a first input feature 108 and a second input feature 110. The first input feature 108 and/or the second input feature 110 may include a dial designed to rotate and provide an input to the electronic device 100 by rotation. Alternatively, the first input feature 108 and/or the second input feature 110 may include a button designed to depress in a direction toward the enclosure 102 in response to a force and provide an input to the electronic device 100 by the depression. The display assembly 104, protective cover 106 first input feature 108 and/or the second input feature 110 may each be used to generate an input or command to a processor circuit (not shown) in the electronic device 100. Additional input interfaces can be included as the circumstances dictate. In response to the input or command, the processor circuit may use an executable program stored on a memory circuit (not shown) to change the visual information displayed on the display assembly 104. Also, the electronic device 100 may include one or more radio circuits (not shown) that provide the electronic device 100 with wireless communication capabilities to, such as Bluetooth or 802.11 (Wi-Fi) protocol, connect to a network as well as pair with an additional electronic device.

Also, as shown in the enlarged view, the enclosure 102 and the protective cover 106 are separated by an opening 116 at an interface region between the enclosure 102 and the protective cover 106. Opening 116 can be at a top region of the electronic device 100 as illustrated, or along a side portion, or any other location where the protective cover interfaces with the enclosure, depending on the design of the interface. In some cases, when the electronic device 100 is exposed to a liquid, the liquid may enter through the opening 116. For such circumstances, the electronic device 100 may include a sealing element designed to prevent further ingress of the liquid through the electronic device 100. This is shown and described below.

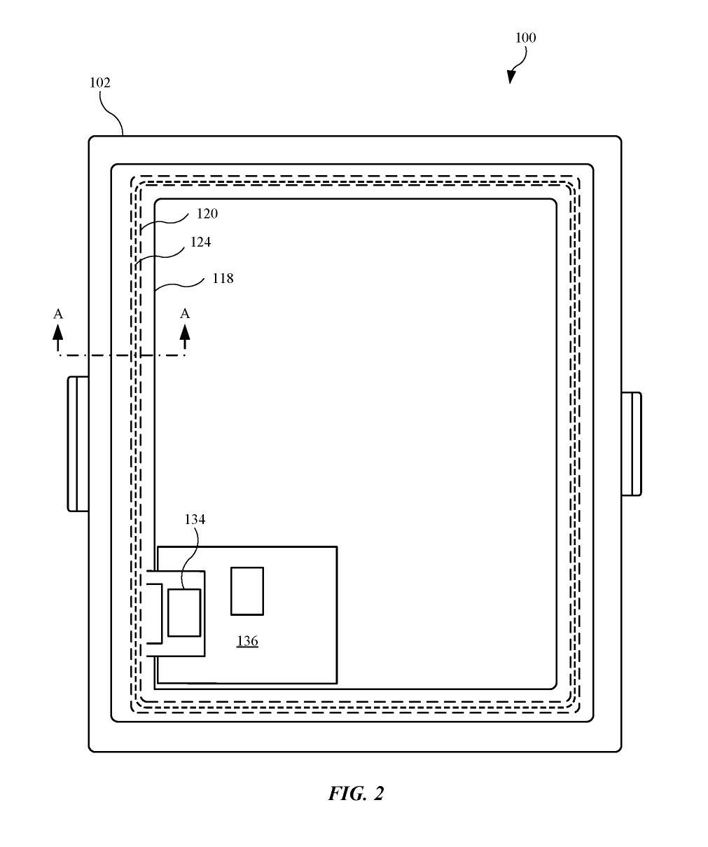

FIG. 2 illustrates a plan view of the electronic device 100 shown in FIG. 1, showing several internal components of the electronic device 100. For purposes of simplicity and illustration, the display assembly 104 and protective cover 106 (both shown in FIG. 1) as well as several internal features, such as a processor circuit, memory circuit, and battery, are not shown here. As illustrated, the enclosure 102 includes a first sealing surface 118. The first sealing surface 118 may include a generally flat surface designed to contact a sealing element 120 (shown as a dotted line) positioned along, the first sealing surface 118. When the protective cover 106 is secured with the enclosure 102, the sealing element 120 provides a seal, in a manner similar to a gasket, against ingress of liquids or contaminants that may pass through the opening 116 (shown in FIG. 1). A processor 134 is shown connected to a printed circuit board (PCB) 136 that can contain other circuitry (not shown) for operating the electronic device components such as the display 104. Processor 134 can be connected to the sensor 124 by any one of various known methods.

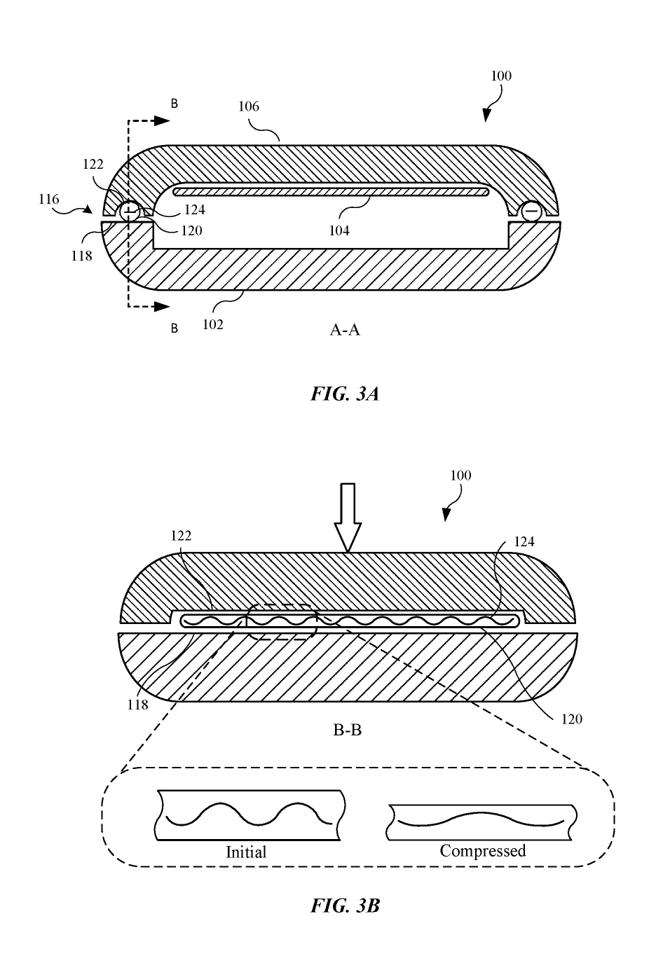

FIG. 3A illustrates a schematic cross section view of electronic device 100 shown in FIG. 2 taken along cross-section A-A. Sealing element 120 can be seen positioned between enclosure 102 and protective cover 106. Sealing element 120 is shown in contact with first sealing surface 118 of enclosure 102. In addition, sealing element is shown contacting a second sealing surface 122 of protective cover 106. To provide a sufficient ingress barrier, sealing element 120 can be compressed between the first sealing surface 118 and the second sealing surface 122 to an initial compression level. An exemplary initial compression level can be 10% for preventing ingress of liquid. At any rate, sealing element is positioned to block ingress of liquid and receive a force from protective cover. Sealing element is shown here as circular in cross-section, but sealing element 120 can take many alternative cross-section forms including rectangular, triangular, elliptical, pill shaped, symmetrical or asymmetrical, just to name a few. In addition to providing an ingress barrier, the sealing element 120 can include an embedded sensor 124 (shown in greater detail in FIG. 3B) designed to detect an amount of force applied to the protective cover 106.

FIG. 3B illustrates a side cross-section view along B-B of FIG. 3A, showing sealing element 120 with embedded sensor 124. Embedded sensor 124 can take the form of a conductive material, such as a metal foil or wire, embedded within sealing element 120 in a selected pattern. As shown in FIG. 3B, a modification to the shape of the sealing element 120, such as due to a compressive force being applied to the sealing element, from an initial position to a compressed position can cause the pattern of the conductive material change. This shape change can result in a change in electrical resistance through the conductive material of the sensor 124. This resistance change can be measured and converted into a signal related to the force imparted on the sealing element 120 by virtue of the force applied to protective cover 106. To accommodate the operation of the embedded sensor 124, sealing element 120 can be formed of a low durometer material, such as silicone, that has sufficient hardness for preventing ingress of liquid, but also has the sufficient softness such that sealing element 120 can be compressed or otherwise modified in shape, and the sensor 124 can react to and detect an imparted force. In some embodiments, sealing element can be formed by over-molding the sealing element material around the embedded sensor so that the sensor is wholly contained by the sealing element material except at points where contacts are formed to connect the sensor to a processor 134 of the electronic device 100.

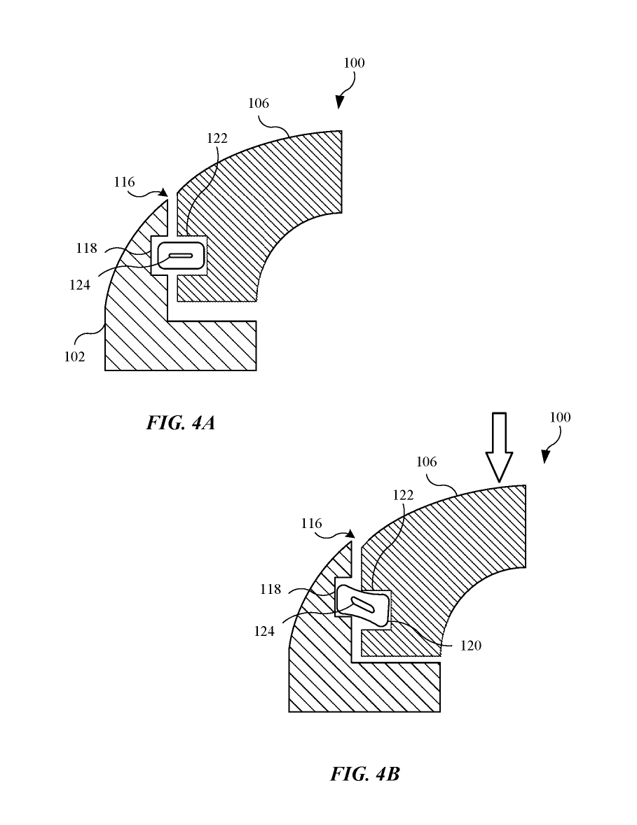

FIG. 4A illustrates sealing element 120 with embedded sensor 124 in another sealing embodiment. As can be seen, enclosure 102 can be configured such that first sealing surface 118 is a groove arranged opposite second sealing surface 122, also a groove, in protective cover 106. In this embodiment, movement of protective cover 106 with respect to enclosure 102, due to a force applied to protective cover 106, can cause a face of protective cover 106 to translate across a face of enclosure 102. This configuration can cause a shearing force to be applied to sealing element 120. The shearing force imparted on sealing element 120, as seen in FIG. 4B, again can change the electrical resistance of the embedded sensor 124, by contorting or twisting sealing element 120 and thereby changing the shape of embedded sensor 124. This resistance change can be measured and used to detect the force imparted on the protective cover 106.

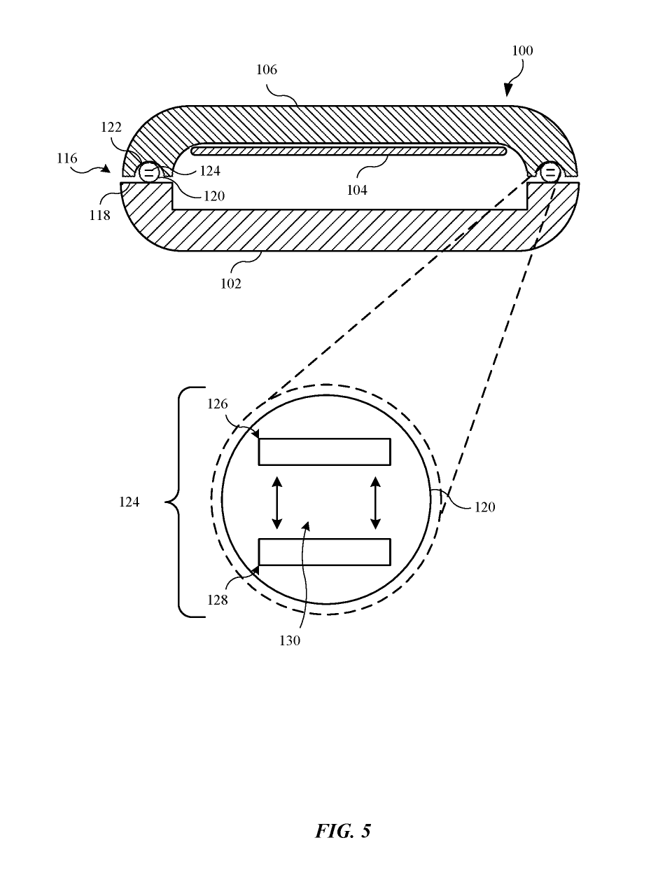

FIG. 5 illustrates an embodiment of an embedded sensor where the sensor 124 can include a pair of flexible circuits that combine to form a parallel plate capacitor separated by the compressible and electrically nonconductive dielectric material of the sealing element 120, such as silicone in region 130. In this regard, sensor 124 can be composed of flexible circuits 126 and 128 that may be electrically coupled with processor 134 (disposed on a Printed circuit board 136) shown in FIG. 2, such that one of the flexible circuits stores electrical charge, creating a voltage difference between the flexible circuits.

More specifically, FIG. 5 further illustrates an enlarged portion of the sealing element 120 further showing the embedded sensor as flexible circuits contained by the sealing element 120. As shown, the sensor 124 may include a first flexible circuit 126 and a second flexible circuit 128, with the first flexible circuit 126 and the second flexible circuit 128 combining to surround a central region 130 of sealing element 120. In some embodiments, the central region 130 is the sealing element material itself. In some embodiments central region 130 can be a different material of a non-electrically conductive dielectric material. The central region 130 can include compressible properties that allow the central region 130 to compress in response to receiving a force. For example, a force exerted on the protective cover 106 may be transmitted in part to the central region 130, causing the central region 130 to compress.

In some embodiments, the sealing element 120 uses the first flexible circuit 126 and the second flexible circuit 128 to form a parallel plate capacitor separated by a distance defined by the central region 130. In this regard, the first flexible circuit 126 may store electrical charge, creating a voltage difference between the first flexible circuit 126 and the second flexible circuit 128. The measure of capacitance, or capacitance value, of the sealing element 120 is inversely proportional to the distance between flexible circuits. Accordingly, a compression of the central region 130 may change the capacitance of the sealing element 120. In some embodiments, a force to the protective cover 106 causes the central region 130 to compress, which causes 1) the distance between the flexible circuits to decrease, and 2) the capacitance of the sealing element 120 to increase. This change in capacitance can be used to detect the force applied to protective cover 106.

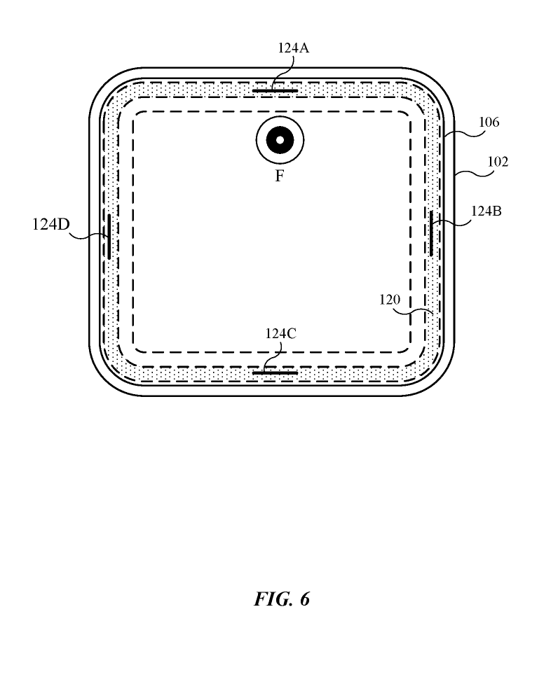

FIG. 6 illustrates an embodiment where the multiple sensors are embedded within sealing element 120 in select locations. Whereas in some embodiments the embedded sensor 124 can completely or nearly completely surround an internal volume of enclosure 102, in the same manner as the sealing element completely or nearly completely surround an internal volume of enclosure 102, here, the embedded sensors 124A, 124B, 124C and 124D can be positioned at specific locations of the sealing element 120. Arranging the embedded sensors in this way can allow for different forces and a location of a force to be detected in some circumstances. For example, if protective cover 106 is coupled to enclosure 102 in such a way that protective cover 106 can toggle in addition to being translated with respect to enclosure 102, in response to a force applied to protective cover 106, embedded sensors 124A, 124B, 124C and 124D can detect a location of a force F imparted to the protective cover 106. For instance, a force imparted in the middle of protective cover 106 would be detected by all embedded sensors 124 approximately equally. However, a force F imparted near embedded sensor 124A can result in that embedded sensor 124A detecting a greater compressive force than the forces detected by the other embedded sensors 124B, 124C and 124D. As such an approximate location of the force F can be detected by the embedded sensors 124A, 124B, 124C and 124D.

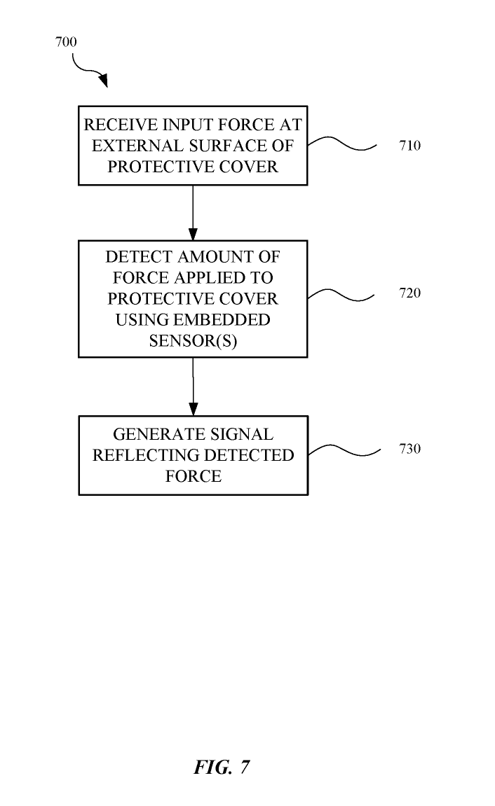

FIG. 7 illustrates a flowchart 700 showing a method for detecting a force applied to on an external surface of the protective cover 106 by a sealing element including an embedded sensor. In a first step 710, the protective cover or input interface can receive a force on an external surface. In a second step, the sensor embedded within the sealing element positioned between the protective cover and an enclosure can detect an amount of force applied to the sealing element by way of the force applied to the external surface of the protective cover transmitted through the protective cover to the sealing element. The detecting can be done by measuring the change in electrical resistance of change in capacitance, among other methods, in the sensor, due to the force applied to the sealing element. In a third step 730 the sensor can generate a signal to provide to a processor based on the detected force applied to the sealing element.

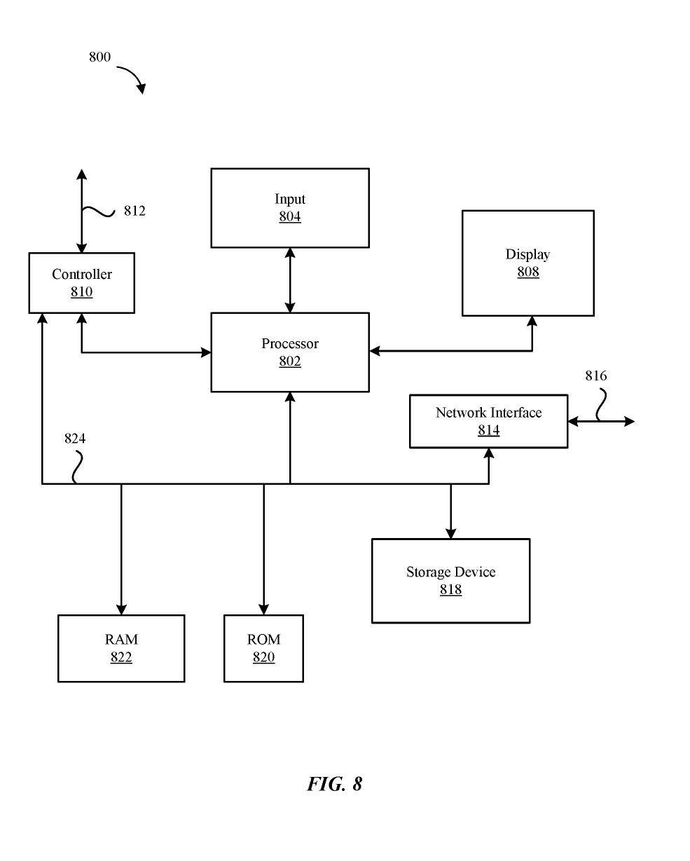

FIG. 8 is a block diagram of a computing device 800 that can represent some of the components of the electronic device. It will be appreciated that the components, devices or elements illustrated in and described with respect to FIG. 8 may not be mandatory and thus some may be omitted in certain embodiments. The computing device 800 can include a processor 802 that represents a microprocessor, a coprocessor, circuitry and/or a controller for controlling the overall operation of the computing device 800. Although illustrated as a single processor, it can be appreciated that the processor 802 can include a plurality of processors. The plurality of processors can be in operative communication with each other and can be collectively configured to perform one or more functionalities of the computing device 800 as described herein. In some embodiments, the processor 802 can be configured to execute instructions that can be stored at the computing device 800 and/or that can be otherwise accessible to the processor 802. As such, whether configured by hardware or by a combination of hardware and software, the processor 802 can be capable of performing operations and actions in accordance with embodiments described herein.

The computing device 800 can also include a user input device 804 that allows a user of the computing device 800 to interact with the computing device 800. For example, the user input device 804 can take a variety of forms, such as a button, keypad, dial, touch screen, audio input interface, visual/image capture input interface, input in the form of sensor data, etc. Still further, the computing device 800 can include a display 808 (screen display) that can be controlled by the processor 802 to display information to a user. A controller 810 can be used to interface with and control different equipment through an equipment control bus 812. The computing device 800 can also include a network/bus interface 814 that couples to a data link 816. The data link 816 can allow the computing device 800 to couple to a host computer or to accessory devices. The data link 816 can be provided over a wired connection or a wireless connection. In the case of a wireless connection, network/bus interface 814 can include a wireless transceiver.

The computing device 800 can also include a storage device 818, and a storage management module that manages one or more partitions (also referred to herein as “logical volumes”) within the storage device 818. In some embodiments, the storage device 818 can include flash memory, semiconductor (solid state) memory or the like. Still further, the computing device 800 can include Read-Only Memory (ROM) 820 and Random Access Memory (RAM) 822. The ROM 820 can store programs, code, instructions, utilities or processes to be executed in a non-volatile manner. The RAM 822 can provide volatile data storage, and store instructions related to components of the storage management module that are configured to carry out the various techniques described herein. The computing device 800 can further include data bus 824. The data bus 824 can facilitate data and signal transfer between at least the processor 802, the controller 810, the network/bus interface 814, the storage device 818, the ROM 820, and the RAM 822.

The various aspects, embodiments, implementations or methods and features of the described embodiments can be used separately or in any combination. Various aspects of the described embodiments can be implemented by software, hardware or a combination of hardware and software, such as on computing device 800 described above. The described embodiments can also be embodied as computer readable code on a computer readable medium for controlling machining operations. In this regard, a computer readable storage medium, as used herein, refers to a non-transitory, physical storage medium (e.g., a volatile or non-volatile memory device, which can be read by a computer system. Examples of the computer readable medium include read-only memory, random-access memory, CD-ROMs, DVDs, magnetic tape, solid state and optical data storage devices. The computer readable medium can also be distributed over network-coupled computer systems so that the computer readable code is stored and executed in a distributed fashion.

As such, some embodiments include an electronic device having a housing that defines an interior volume, the housing being suitable for carrying at least a processor within the internal volume, the housing comprising an edge that defines an opening that provides access to the internal volume. The electronic device can have a cover carried at the edge of the housing and within the opening and having an external surface capable of receiving an external force and a sealing element disposed between the housing and the cover, with the sealing element preventing intrusion of liquid into the internal volume. The sealing element can include a sealing material and a sensor contained within the sealing material that senses that an external force is applied to the external surface of the cover and, in response, provides a signal to the processor.

In some embodiments, the sensor comprises an electrically conductive material arranged in a pattern having a shape. In some embodiments, the pattern is cyclical. In some embodiments, when the external force is applied to the cover glass, the sealing element is compressed causing the sealing element to change shape resulting in a commensurate change in the signal provided to the processor. In some embodiments, the compression of the sealing element causes the pattern to distort causing the resistance of the sensor to decrease. In some embodiments, the sealing material is a low durometer non-electrically conductive elastomer. In some embodiments, the sealing element is disposed between the enclosure and cover such that when the external force is applied to the cover, the sealing element exhibits a shear force due to the movement of the cover with respect to the enclosure. In some embodiments, the sealing material is a dielectric and the sensor is comprised of two electrically conductive plates arranged opposite each other and spaced apart by at least a portion of the sealing element. Some embodiments can include a display and wherein the processor controls content displayed at the display based on the signal provided to the processor by the sensor. In some embodiments, the sealing element comprises multiple sensors embedded within the sealing material and each sensor provides a signal to the processor for the force applied to the external surface of the cover.

Some embodiments can include a portable electronic device having an enclosure defining an internal cavity configured for carrying electronic components including at least a processor and a display, the enclosure having an edge at an opening to the internal cavity and a cover glass disposed on the edge and over the display such that visual content is displayed through the cover glass, the cover glass being coupled to enclosure. The portable electronic device can have a liquid impermeable barrier compressed between the cover glass and the edge such that liquid is prevented from permeating into the internal cavity of the enclosure, where the liquid impermeable barrier can include a sensor embedded within the liquid impermeable barrier that can detect a force applied to an external surface of the cover glass and provide a signal to the processor.

In some embodiments, the liquid impermeable barrier is formed of silicone. In some embodiments, the sensor is strain gauge configured to detect compressive forces from the cover glass. In some embodiments, the sensor is a strain gauge configured to detect shear forces on the liquid impermeable barrier caused by movement between the cover glass and the enclosure interface between the cover glass and the enclosure. In some embodiments, the sensor comprises two electrically conductive elements spaced apart by a portion of the liquid impermeable barrier and a change in capacitance between the elements indicates an applied force to the external surface of the cover glass.

Some embodiments can include method for detecting a touch force input received at an external surface of a first component of a multi-part electronic device enclosure, where the first component is coupled to a second component and sealed from liquid permeation by a sealing element embedded with a force sensor arranged between the first component and the second component. The method can include receiving a force at an external surface of the first or second component, detecting the force received by the protective cover and transmitted to the sealing element, using the embedded force sensor, and generating a signal to provide to a processor contained within the multi-part electronic device enclosure based on the detected force.

Some embodiments include controlling content displayed at a display carried by the electronic device based on the signal received from the sensor. In some embodiments, the sensor comprises a sensor element arranged in a cyclical pattern shape that changes resistance when compressed and generates the signal to the processor. In some embodiments, the signal comprises an amount of force applied to the external surface of the protective cover. In some embodiments, the sealing element is formed of silicone over-molded over the sensor.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device comprising:
a housing that defines an interior volume, the housing being suitable for carrying at least a processor within the internal volume, the housing comprising an edge that defines an opening that provides access to the internal volume;
a cover carried at the edge of the housing and having an external surface capable of receiving an external force; and
a sealing element disposed between the housing and the cover, the sealing element preventing intrusion of liquid into the internal volume, the sealing element comprising a sealing material and a sensor contained within the sealing material that senses that an external force is applied to the external surface of the cover and, in response, provides a signal to the processor.

2. The electronic device of claim 1, wherein the sensor comprises an electrically conductive material arranged in a pattern having a shape.

3. The electronic device of claim 2, wherein the pattern is cyclical.

4. The electronic device of claim 3, wherein when the external force is applied to the cover, the sealing element is compressed causing the sealing element to change shape resulting in a commensurate change in the signal provided to the processor.

5. The electronic device of claim 4, wherein the compression of the sealing element causes the pattern to distort causing the resistance of the sensor to decrease.

6. The electronic device of claim 5, wherein the sealing material is a low durometer non-electrically conductive elastomer.

7. The electronic device of claim 1, wherein the sealing element is disposed between the enclosure and cover glass such that when the external force is applied to the cover glass, the sealing element exhibits a shear force due to the movement of the cover glass with respect to the enclosure.

8. The electronic device of claim 1, wherein the sealing material is a dielectric and the sensor is comprised of two electrically conductive plates arranged opposite each other and spaced apart by at least a portion of the sealing element.

9. The electronic device of claim 1, further comprising a display and wherein the processor controls content displayed at the display based on the signal provided to the processor by the sensor.

10. The electronic device of claim 1, wherein the sealing element comprises multiple sensors embedded within the sealing material and each sensor provides a signal to the processor for the force applied to the external surface of the cover.

11. A portable electronic device comprising:
an enclosure defining an internal cavity configured for carrying electronic components including at least a processor and a display, the enclosure having an edge at an opening to the internal cavity;
a cover glass disposed on the edge and over the display such that visual content is displayed through the cover glass, the cover glass being coupled to enclosure; and
a liquid impermeable barrier compressed between the cover glass and the edge such that liquid is prevented from permeating into the internal cavity of the enclosure, the liquid impermeable barrier comprising a sensor embedded within the liquid impermeable barrier that detects a force applied to an external surface of the cover glass and provide a signal to the processor.

12. The portable electronic device of claim 11, wherein the liquid impermeable barrier is formed of silicone.

13. The portable electronic device of claim 11, wherein the sensor is strain gauge configured to detect compressive forces from the cover glass.

14. The portable electronic device of claim 11, wherein the sensor is a strain gauge configured to detect shear forces on the liquid impermeable barrier caused by movement between the cover glass and an interface between the enclosure and the cover glass and the enclosure.

15. The portable electronic device of claim 11, wherein the sensor comprises two electrically conductive elements spaced apart by a portion of the liquid impermeable barrier and a change in capacitance between the elements indicates an applied force to the external surface of the cover glass.

16. A method for detecting a touch force input received at an external surface of a protective cover coupled to an enclosure of en electronic device, where the enclosure is sealed from liquid permeation by a sealing element embedded with a force sensor arranged between the protective cover and the enclosure, the method comprising:
receiving a force at an external surface of the protective cover;
detecting the force received by the protective cover and transmitted to the sealing element, using the embedded force sensor; and
generating a signal to provide to a processor contained within the enclosure based on the detected force.

17. The method of claim 16, further comprising controlling content displayed at a display carried by the electronic device based on the signal received from the sensor.

18. The method of claim 16, wherein the sensor comprises a sensor element arranged in a cyclical pattern shape that changes resistance when compressed and generates the signal to the processor.

19. The method of claim 16, wherein the signal comprises an amount of force applied to the external surface of the protective cover.

20. The method of claim 16, wherein the sealing element is formed of silicone over-molded over the sensor.
